(19) United States
(12) Patent Application Publication
(10) Pub. No.: US 2005/0167466 A1
(43) Pub. Date: Aug. 4, 2005

(54) Drive mechanism for an electric nailer

(75) Inventor: Dandy Tsai, Taichung (TW)

Correspondence Address: CHARLES E. BAXLEY, ESQ., 90 JOHN STREET, THIRD FLOOR, NEW YORK, NY, 10038, US

(73) Assignee: Acuman Power Tools Corp.

(21) Appl. No.: 11/098,683

(22) Filed: Apr. 4, 2005

Related U.S. Application Data
(63) Continuation-in-part of application No. 10/616,741, filed on Jul. 9, 2003.

(51) Int. Cl. B25C 5/06

(52) U.S. Cl. 227/131

(57) ABSTRACT

A drive mechanism for an electric nailer comprises a power source, an electromagnetic coil, a control unit and moving member, which are disposed in a housing. The power source provides the electromagnetic coil and the control unit with DC power at predetermined voltage, so as to enable them to generate electromagnetic force. The control unit serves to control the output of the DC power source at a standard reference potential, so that the control unit is capable of turning on the electromagnetic coils at any time points.

This application is a Continuation-in-Part of U.S. patent application Ser. No. 10/616,741, filed Jul. 9, 2003, to which application priority is claimed.

### BACKGROUND OF THE INVENTION

1. Field of the Invention

The present invention relates to a drive mechanism for an electric nailer, and more particular to a drive mechanism for an electric nailer is capable of performing nail-striking action non-intermittently.

2. Description of the Prior Arts

A conventional electromagnetic nailer of an electric nailer generally comprises: a switch control (such as), an electromagnetic coil, a ram connected with a piston rod and an elastic member. When the electromagnetic coil is turned on, the ram will be ready to do the nail-striking action, and after each time of nail-striking action, the ram will be returned back to its original non-operative position by the elastic member. However, in real operation, this type conventional electromagnetic nailer still has the following disadvantages that need to be improved:

First, as shown FIG. 1, since a conventional electromagnetic nailer is normally AC powered, and AC power is a current or voltage (it usually take the form of sine wave) whose flow direction is reversed periodically, the switch control will accordingly be turned on, starting from the first point 111 of the positive cycle 11, so as to enable the electromagnetic coil to produce electromagnetic force. And the switch control will be turned off at the second point 112 of the positive cycle 11, so that the no magnetic force is produced at this moment, thus stopping the nail-striking action. While during the negative cycle 12, the electromagnetic coil is turned off and unable to produce electromagnetic force, at this moment no nail-striking action can be performed. Obviously, this conventional electric tool is only capable doing nail-striking at specific time points.

The present invention has arisen to mitigate and/or obviate the afore-described disadvantages of the conventional electric tool.

### SUMMARY OF THE INVENTION

In accordance with one respect of the present invention, there is provided an operation-time controllable drive mechanism for an electric nailer, which comprises a power source, an electromagnetic coil, a control unit and a moving member that are disposed in a housing. The power source provides the electromagnetic coil and the control unit with DC power at predetermined voltage, so as to enable them to generate electromagnetic force. The control unit serves to control the output of the DC power source at a standard reference potential, so that the control unit is capable of turning on the electromagnetic coils at any time points.

The primary object of the present invention is to provide a drive mechanism for an electric nailer that its duration of operation is controllable, with the help of a DC power source and a control unit, the electric nailer is capable of performing nail-striking action non-intermittently, and the work efficiency is improved.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a schematic diagram of illustrating the electric wave of an AC for a conventional electric nailer;

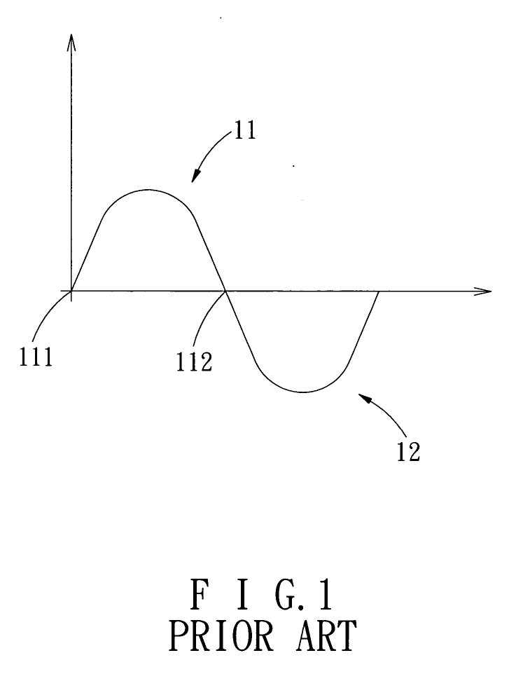

FIG. 2 is a flow chart in accordance with the present invention of illustrating the method for controlling operation time of an electric nailer;

FIG. 3 is a cross-sectional view of an electric nailer equipped with control unit in accordance with the present invention;

FIG. 4 is a circuit diagram of the present invention;

FIG. 5 is a schematic diagram of illustrating the electric wave of a DC for the electric nailer of the present invention.

### DETAILED DESCRIPTION OF THE PREFERRED EMBODIMENT

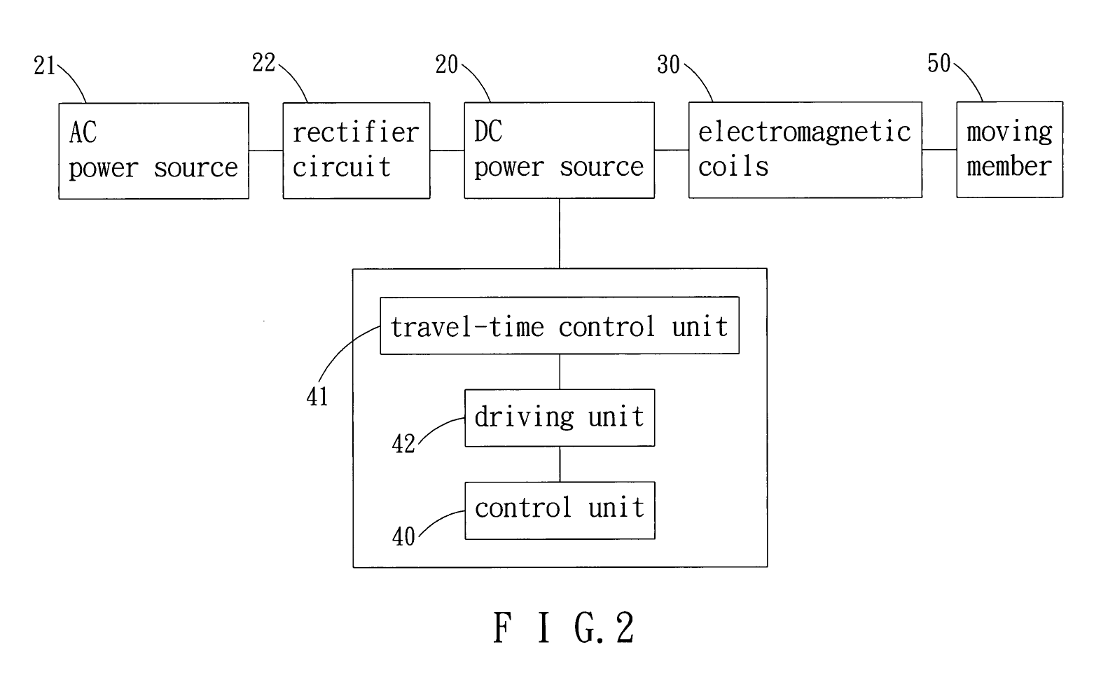

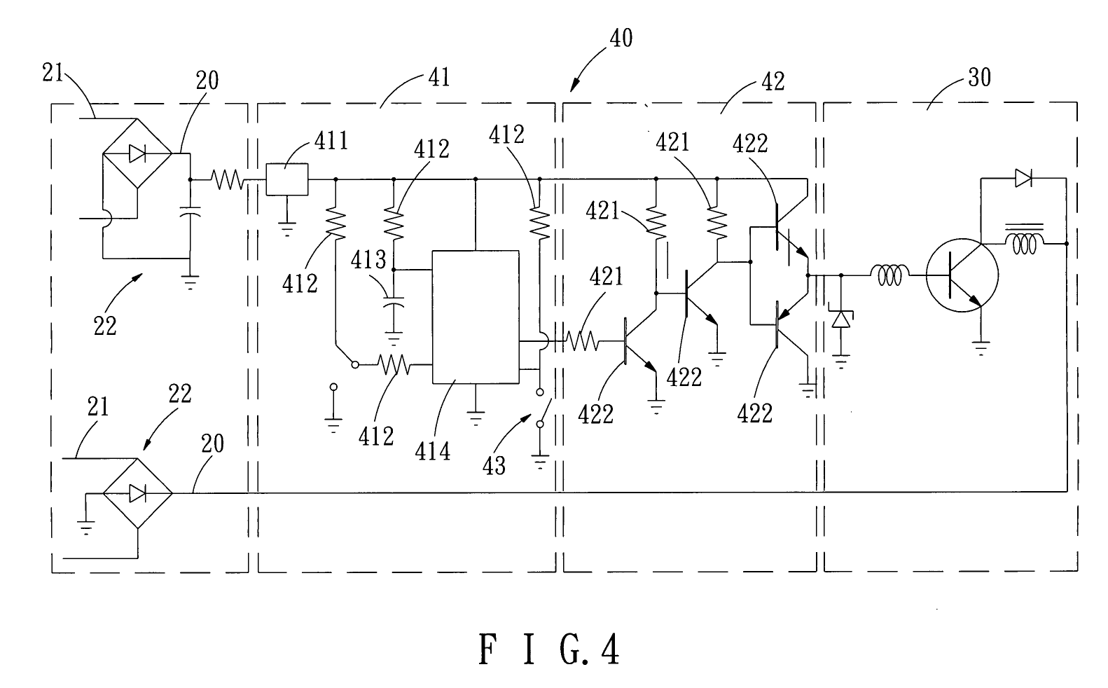

Referring to FIGS. 2-4, a drive mechanism for an electric nailer is illustrated and comprises: a power source 20, an electromagnetic coil 30, a control unit 40 and a moving member 50.

The power source 20 is a DC power with a predetermined voltage, which can be obtained directly by converting an AC power source 21 into DC power through a rectifier circuit 22. Due to the rectifying method is of conventional arts, further remarks on this matter will be omitted. It will be noted that the power source 20 also can be produced by a dry DC battery.

The electromagnetic coil 30 is made of wire winding 31 and is interiorly defined with a passage 32, the electromagnetic coil 30 is powered by the power source 20 so as to produce a magnetic force.

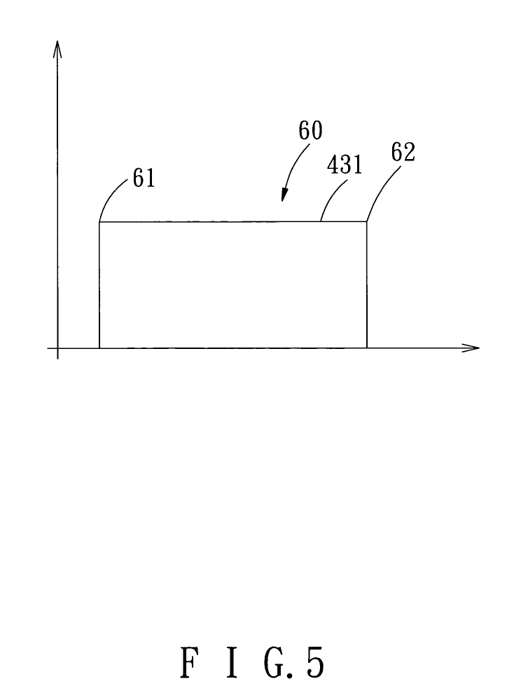

The control unit 40 includes a time-control unit 41 connected with a driving unit 42. The time-control unit 41 is connected to the power source 20, while the driving unit 40 is connected to the electromagnetic coil 30. The time-control unit 41 includes a voltage regulation element 411, four current limit resistances 412, a time-control condenser 413 and a time-control circuit 414. The time-control unit 41 is under the control of a push switch 43 that is able to control the output of the DC power source to a standard reference potential 431 or a predetermined potential 432 (as shown in FIG. 5). The driving unit 42 includes three voltage-divider resistances 421 and four driving electric crystals 422, which serve to activate the electromagnetic coil 30.

The moving member 50 is a ram having a striking pin element 51 fixed at the front end thereof, and to a rear end of the moving member 50 is connected an elastic member 52. The moving member 50 is movably received in the passage 32 of the electromagnetic coil 30.

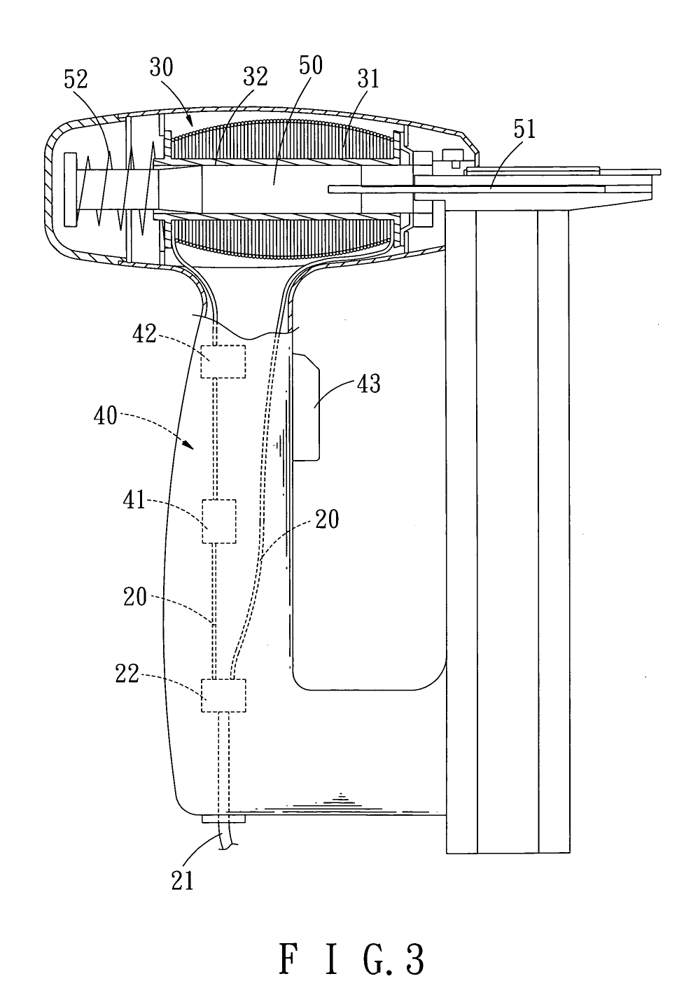

Referring to FIGS. 3 and 5, due to the output of the power source 20 is DC power, the voltage, the polarity and the intensity of electric current of the DC power source won't be changed with time, the time-control unit 41 of the control unit 40 can be energized simply by turning on the push switch 43 during the period of time from the first time point 61 to the second time point 62 of the electric wave 6 (predetermined potential 432), and then the driving unit 42 will be caused to activate or energize the electromagnetic coil 30, resulting in a nail-striking motion of the moving member 50. Thereby the electric nailer in accordance with the present invention is capable of performing nail-striking action non-intermittently.

While we have shown and described various embodiments in accordance with the present invention, it should be clear to those skilled in the art that further embodiment may be made without departing from the scope of the present invention.

1. A drive mechanism for an electric nailer comprising:
a power source for outputting a power at a predetermined voltage;
an electromagnetic coil connected to the power source and employed to produce a magnetic force;
a control unit connected to the power source and employed to activate the electromagnetic coil;
a moving member being driven to move by the magnetic force produced by the electromagnetic coil;
a time-control unit connected with a driving unit, the time-control unit connected to the power source, and the driving unit connected to the electromagnetic coil;
wherein the power source outputs DC power at a predetermined voltage, so as to enable the electromagnetic coil to produce electromagnetic force, and to enable the control unit to activate the electromagnetic coil, the control unit serves to control the output of the DC power at a standard reference potential, therefore, the control unit is capable of activating the electromagnetic coil at any period of time, enabling the electric nailer to perform nail-striking action continuously and non-intermittently.

2. The drive mechanism for an electric nailer as claimed in claim 1, wherein the time-control unit includes a voltage regulation element, four current limit resistances, a time-control condenser and an integrated circuit (IC).

3. The drive mechanism for an electric nailer as claimed in claim 1, wherein the driving unit includes three voltage-divider resistances and four transistors and serves to activate the electromagnetic coil.

4. The drive mechanism for an electric nailer as claimed in claim 1, wherein the moving member is a ram having a striking pin connected at an end thereof.
